(19) United States
(12) Patent Application Publication
(10) Pub. No.: US 2018/0078080 A1
(43) Pub. Date: Mar. 22, 2018

(54) FLUID INFUSING APPARATUS

(71) Applicant: KEENWAWA, INC., SAN FRANCISCO, CA (US)

(72) Inventors: SCOTT DRUMMOND, SAN FRANCISCO, CA (US); RYAN DECOSTER, PACIFICA, CA (US); NATE LAMBERTY, ALAMEDA, CA (US); DAMIAN A HAJDUK, SAN JOSE, CA (US); JOHN MAURIELLO, SAN FRANCISCO, CA (US)

(21) Appl. No.: 15/272,289

(22) Filed: Sep. 21, 2016

(51) Int. Cl. A47J 31/06

(52) U.S. Cl. CPC A47J 31/0636

(57) ABSTRACT

A device for infusing flavor into a fluid, as shown and described in any one or more of the drawing figures and/or any one or more paragraphs of the text. A method of infusing flavor into a fluid, as shown and described in any one or more of the drawing figures and/or any one or more paragraphs of the text. A beverage serving system comprising a cup having a flexible ring integrally formed with an outer wall of the cup; a lid adapted to snugly engage with and cover a top opening of the cup, and having at least one cavity in a top surface of the lid; a flavor infusing device comprising an elongated body having perimeter dimensions that fit into or through the ring.

### FIELD OF THE DISCLOSURE

The technical field of this disclosure is apparatus for infusing fluids, such as beverages, with flavor from a material that is contained in the apparatus. The technical field of the disclosure relates more specifically to infusers, carriers, tubes, lids, stirrers, and other structures that are used in connection with fluids or beverages. The disclosure also encompasses the ornamental designs of fluid infusing apparatus in several different forms.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Infusing fluids with flavor is inconvenient, messy or difficult using presently available techniques. Making tea, for example, historically has required the use of a cumbersome perforated device, or mesh item, such as a tea bag. One disadvantage of this approach is that aromatic properties of the contents of the bag or device are not easily sensed, using the nose, at the time that the bag or device is used. Another disadvantage is that placing a bag or device into a closed cup is not easy.

Infusing coffee imposes a separate set of constraints. For example, studies have shown that consumers do not want to drop tea bags into cups of coffee, as the act produces a visceral negative reaction. Therefore, viscous fluids such as syrups typically are used to add flavor to coffee but it is not possible to produce a syrup for every desirable flavor to be infused. Syrups also necessarily include a large sugar component that adds calories to the beverage, which some users seek to avoid. In addition, practical dispensing of viscous liquids usually requires a large vessel with a strong pump; single servings are difficult to accomplish and typically require a messy packet or package.

### BRIEF DESCRIPTION OF DRAWINGS

FIG. 1A is a front elevation view and FIG. 1B is a side elevation view of an embodiment of a flavor infusing device.

FIG. 1C is a partial enlarged perspective view of the embodiment of FIG. 1A, FIG. 1B illustrating one or more holes 102 in the cap

FIG. 1D is a perspective view of the device of FIG. 1A, FIG. 1B, FIG. 1C in a beverage serving system.

FIG. 1E is a perspective view of the system of FIG. 1D in which the flavor infusing device has been removed from the ring and placed into the cup through a hole in the lid.

FIG. 2A, FIG. 2B, FIG. 2C illustrate another embodiment of a flavor infusing device.

FIG. 2D, FIG. 2E illustrate a beverage system comprising a cup, lid, retaining ring and device as seen in FIG. 2A, FIG. 2B, FIG. 2C.

FIG. 3A, FIG. 3B, FIG. 3C, FIG. 3D illustrate another embodiment of a flavor infusing device and system.

FIG. 4A, FIG. 4B, FIG. 4C, FIG. 4D illustrate another embodiment of a flavor infusing device and system

FIG. 5A, FIG. 5B, FIG. 5C illustrate another embodiment of a flavor infusing device and system.

FIG. 6A, FIG. 6B are side elevation views of another embodiment of a flavor infusing device.

FIG. 7A, FIG. 7B are a front elevation view and a side elevation view of another embodiment of a flavor infusing device.

FIG. 8 is an exploded perspective view of the embodiment of a flavor infusing device as seen in FIG. 4A, FIG. 4B, FIG. 4C, FIG. 4D.

FIG. 9A and FIG. 9B illustrate examples of caps that may be recessed in the elongated body of a flavor infusing device, for example in the devices of FIG. 2A, FIG. 2B.

FIG. 10 is a side elevation of another embodiment of the body of the flavor infusing device of FIG. 7A, FIG. 7B to clearly illustrate an example of perforations and an ornamental pattern of the perforations.

FIG. 11A, FIG. 11B, FIG. 11C illustrate various embodiments of a body of a flavor infusing device and show alternatives or variants in perforation patterns, perforation locations, upper end profiles, and body profiles or cross-sections.

FIG. 11D, FIG. 11E, FIG. 11F illustrate various embodiments of a body of a flavor infusing device and show alternatives or variants in perforation patterns, perforation locations, upper end profiles, and body profiles or cross-sections.

FIG. 11G, FIG. 11H, FIG. 11I illustrate various embodiments of a body of a flavor infusing device and show alternatives or variants in perforation patterns, perforation locations, upper end profiles, and body profiles or cross-sections.

FIG. 12A, FIG. 12B illustrate embodiments of a flavor infusing device comprising a top disc, a shaft, and a perforated body.

FIG. 12C, FIG. 12D illustrate embodiments of a flavor infusing device comprising an elongated tapered partly perforated body.

FIG. 13 is a four-part perspective view of a beverage serving system comprising a cup, lid, and flavor infusing device, in one embodiment.

FIG. 14A, FIG. 14B are perspective views of an embodiment of a lid having a rotatable flavor infusing device.

FIG. 15A is an exploded perspective view of a cap and a lid comprising a downwardly extending infusing body.

FIG. 15B is a perspective view of an embodiment of a lid for a cup that comprises an elongated downwardly extending flavor infusing body.

FIG. 16A, FIG. 16B are perspective views of an embodiment in non-dispensed and dispensed positions.

FIG. 17A, FIG. 17B, FIG. 17C illustrate embodiments of a flavor infusing device comprising a top disc, a shaft, and a perforated body.

FIG. 18A, FIG. 18B are partial perspective views of an upper portion of a flavor infusing device showing details of one embodiment of a cap and cap securing apparatus.

FIG. 19A, FIG. 19B are perspective views of a flavor infusing device similar to that of FIG. 18A, FIG. 18B illustrating an alternative cap embodiment, in which the cap comprises a plurality of arcuate slots extending partly around regions of a perimeter of the circular top wall of the cap.

### SUMMARY

The appended claims may serve as a summary of the invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

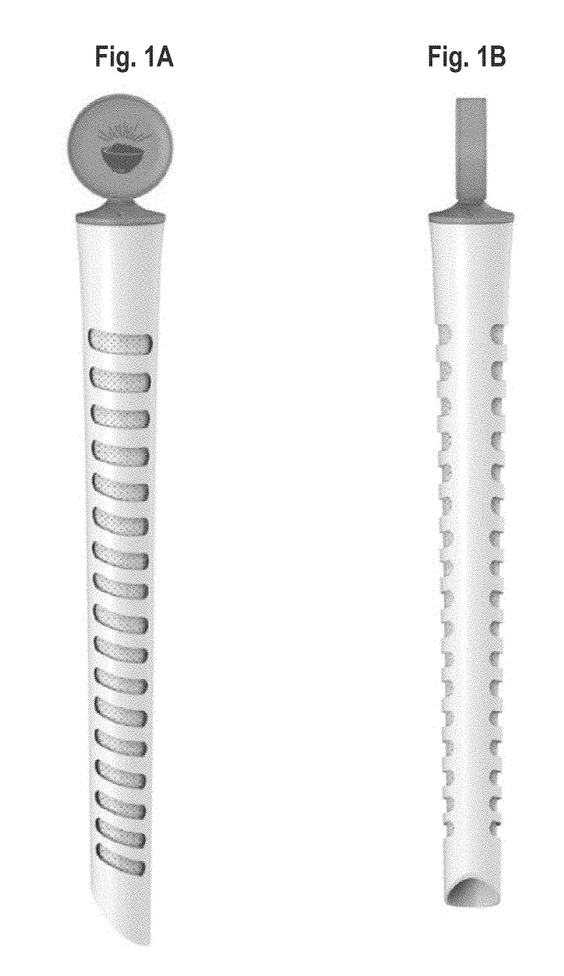

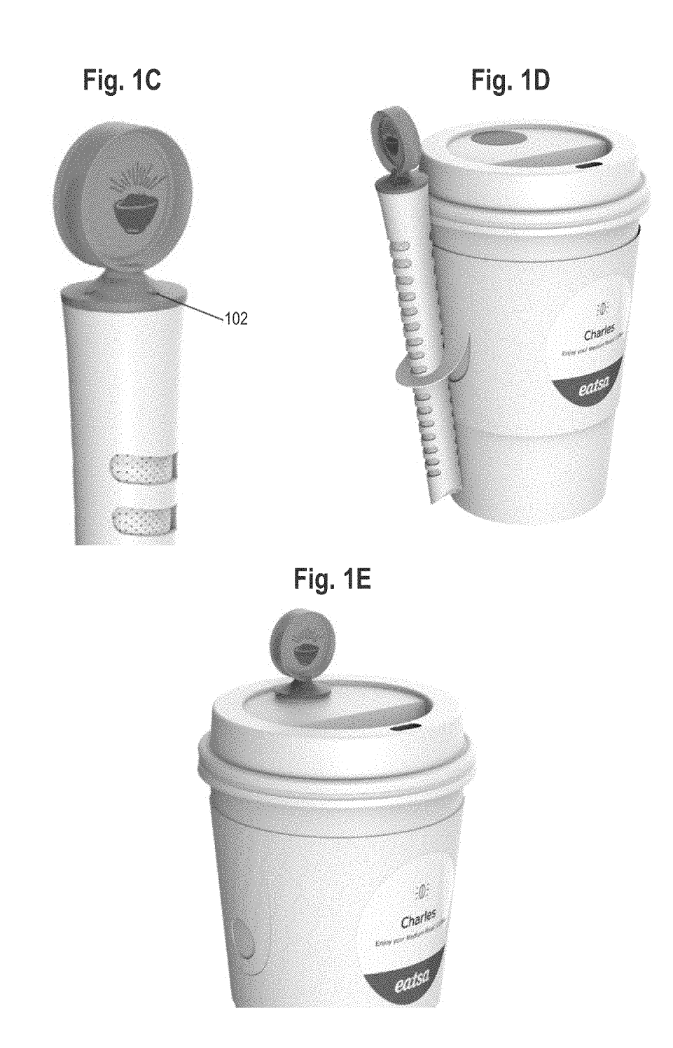

FIG. 1A is a front elevation view and FIG. 1B is a side elevation view of an embodiment of a flavor infusing device. An elongated body comprises an elongated interior cavity, a top opening, a bottom opening, a plurality of slots and a cap. The body may comprise a tube having walls that are relatively thin in comparison to the length and width of the body. The tubular body may be cylindrical, square, rectangular, or have other cross-section shapes including ones that transition, along the length of the body, from one of (cylindrical, square, rectangular, triangular or a variant or blend of these) to another of (cylindrical, square, rectangular, triangular or a variant or blend of these) Embodiments may be implemented as infusers, carriers, tubes, lids, stirrers, and other structures that are used in connection with fluids or beverages, whether hot or cold, as seen in the many examples that are described in other sections and shown in the drawing figures. In the example of FIG. 1A, the cap, which features an upstanding disk in this embodiment, is dimensioned to snugly fit into the top opening of the body to close off the interior cavity. The bottom opening may be beveled or angled to facilitate inserting the body into a corresponding cavity or hole in a lid or top of a beverage cup. Using a cap is not required and in some embodiments, a seal may be used rather than a removable cap. For example, a seal may be applied at a time of manufacture or loading with a material.

The body has longitudinal dimensions that are compatible with and less than the depth of a cup into which the body is intended to be placed. As an example, in FIG. 1A, when the body is placed into a cup, all the slots may be within the cup and may be submerged in a fluid or beverage and the bottom angled or beveled end of the device may rest against or near an interior surface of a bottom wall of the cup. An upper portion of the body may have perimeter dimensions that are greater than the remainder of the body, forming a neck, shoulder or other outwardly extending region that may assist in seating or retaining the body in the hole of the lid of the cup, and slightly above a plane of the top surface of the lid. In this manner, when the device is placed into a fluid or beverage in a cup having a lid, the upper portion of the body remains exposed above the lid and the body cannot fully fall into the fluid or liquid. This position also permits the consumer to perceive aromatic qualities of the material in the body, as further described.

In an embodiment, the interior cavity contains and conceals a mesh or perforated bag, cylinder, or other package that contains a flavor infusing material. Alternatively, the flavor infusing material may be held directly within the interior cavity, with no other bag, cylinder or other package. In either arrangement, when the flavor infusing device is placed in a fluid or beverage, such as within a cup, molecules of the fluid or beverage can pass into the interior cavity of the device and contact or pass over material that is in the interior cavity. Over time, flavor qualities of the material in the interior cavity are imparted to the fluid or beverage. In an embodiment, the material is selected with a grain or particle size that is too large to exit the interior cavity and enter or foul the fluid or beverage, but with sufficiently small size to present a large surface area to the fluid or beverage for rapid infusion. Mixing properties of the material as compared to fluid properties, such as static tension and surface tension, may be traded off as appropriate to yield a useful particle size that results in rapid infusion without fouling the fluid or beverage.

FIG. 1C is a partial enlarged perspective view of the embodiment of FIG. 1A, FIG. 1B illustrating one or more holes 102 in the cap. In an embodiment, these holes permit upward exhaustion of air from within the body of the device when the device is immersed in a fluid or beverage. Further, the holes permit upward exhaustion of aromatic particles, or infused air, when the body is immersed. Consequently, the device permits the user to smell the flavor that is infused, as it is infused.

FIG. 1D is a perspective view of the device of FIG. 1A, FIG. 1B, FIG. 1C in a beverage serving system. In an embodiment, a beverage serving system comprises a cup having a flexible ring integrally formed with an outer wall of the cup; a lid adapted to snugly engage with and cover a top opening of the cup, and having at least one cavity in a top surface of the lid; a flavor infusing device comprising an elongated body having perimeter dimensions that fit into or through the ring. FIG. 1D illustrates such a system in which the flavor infusing device is snugly retained in the flexible ring, which has been flexed outwardly from the cup to permit the body of the device to be placed in the ring. In this arrangement, the flexible ring gently urges the device downwardly against the outer wall of the cup, retaining the device in place against the cup. In addition, the lid comprises both a consumption hole, located in a perimeter annular ridge of the lid, and a circular hole that is adapted to receive a body of the flavor infusing device. Optionally, the circular hole may be sealed with a removable seal or label, such as a printed label having low-tack pressure sensitive adhesive. The circular hole may be positioned in the lid in a spaced apart relationship to the consumption hole.

FIG. 1D may represent, in various embodiments, the configuration of a system at the time that a beverage is served to a customer, in which the cup contains a fluid or beverage, or the configuration of the system at the time of shipment from a maker to a vendor or retailer, in which the cup is empty. Alternatively, the flavor infusing device may be shipped or supplied separately to a customer, vendor or retailer.

FIG. 1E is a perspective view of the system of FIG. 1D in which the flavor infusing device has been removed from the ring and placed into the cup through a hole in the lid. In this arrangement, the cap of the device protrudes from the hole. Further, when the cup lid is raised to the mouth of the consumer, so that the consumption hole is positioned at the mouth, the holes 102 in the cap will be positioned near the nostrils of the consumer. Consequently, aromatic features of the material in the flavor infusing device and/or aromatically infused air will be readily absorbed into the nasal passages of the consumer and therefore enjoyed.

Examples of flavor infusing materials that may be used in any embodiments of this disclosure include teas, spices, nuts whether whole, ground, or chopped, coffees, chicory, sugars, crystallized substances such as honey or citrus, dried fruit, dried vegetables or other plant material, and in general any edible material that may impart flavor to a fluid or beverage, hot or cold, when introduced into that fluid or beverage.

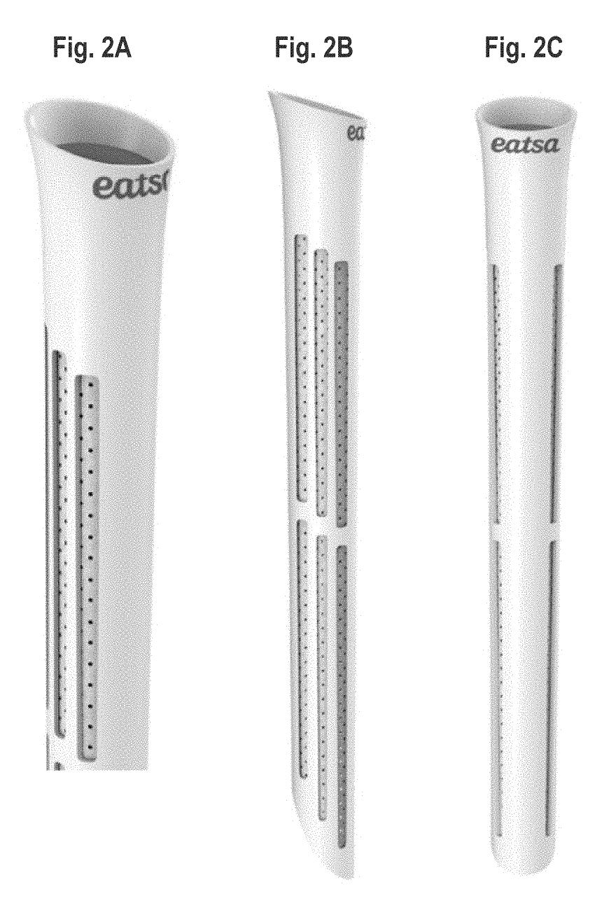

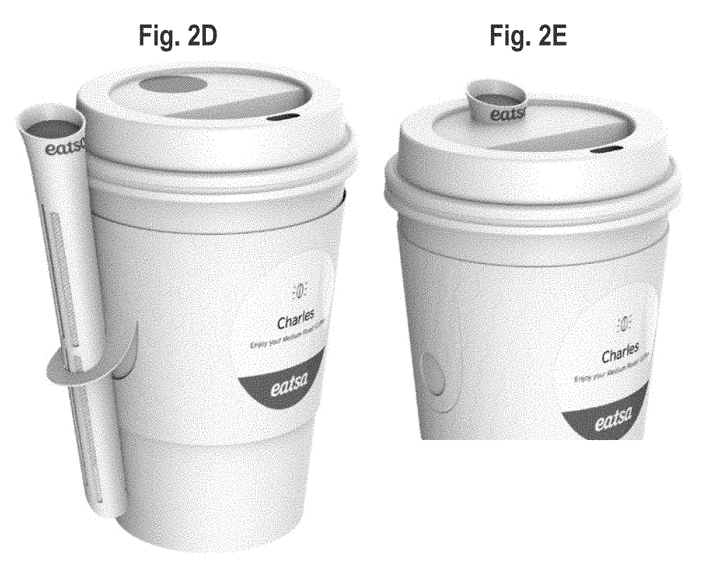

FIG. 2A, FIG. 2B, FIG. 2C illustrate another embodiment of a flavor infusing device. FIG. 2A is an enlarged partial perspective view of a top region, FIG. 2B is a side elevation view, FIG. 2C is a front elevation view. In this embodiment, the body of the device comprises a plurality of spaced apart elongated generally rectangular slots through which a fluid or beverage may enter to contact or pass over the flavored material. In this embodiment, the cap is recessed within the top opening of the elongated body of the device to sit below a perimeter of a top end of the device. The body is generally cylindrical and has an outwardly flared upper portion.

FIG. 2D, FIG. 2E illustrate a beverage system comprising a cup, lid, retaining ring and device as seen in FIG. 2A, FIG. 2B, FIG. 2C. In this embodiment, as seen in FIG. 2E, when the device is placed in the cup, the outwardly flared upper portion of the device causes the top portion of the body to remain above a plane of the lid of the cup. In this manner, holes in the cap of the device will be positioned close to the nose of the consumer when the beverage is consumed.

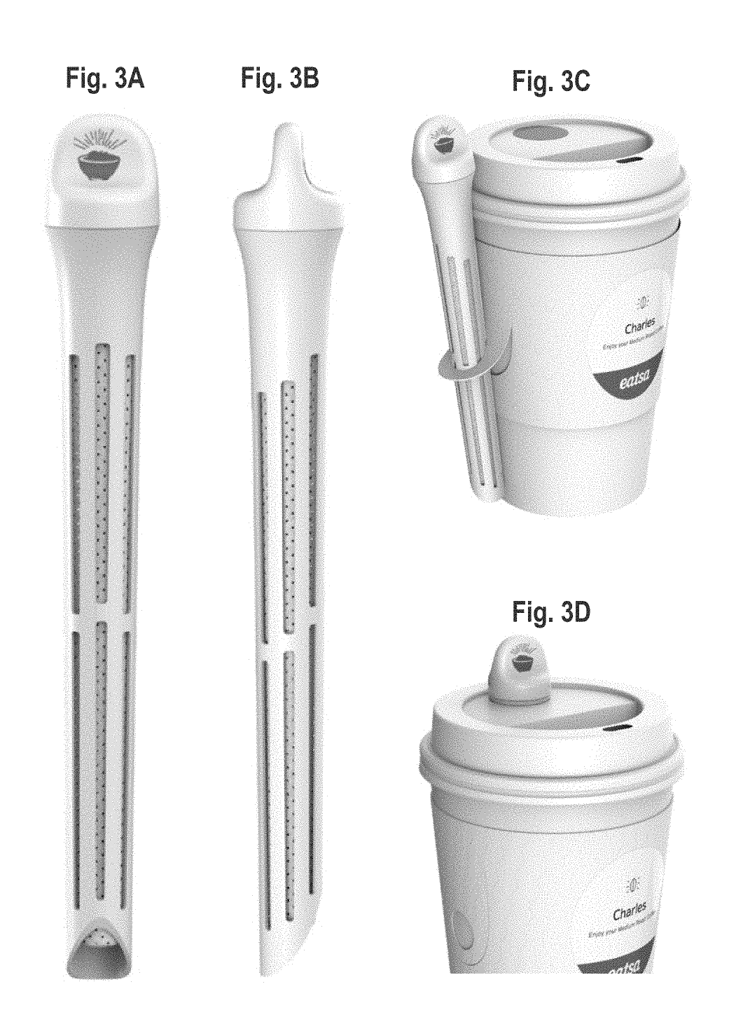

FIG. 3A, FIG. 3B, FIG. 3C, FIG. 3D illustrate another embodiment of a flavor infusing device and system. FIG. 3A is a front elevation view and FIG. 3B is a side elevation view. FIG. 3C is a perspective view of a system comprising a cup, lid, retaining ring and flavor infusing device. FIG. 3D is a perspective view of the system of FIG. 3C showing the device inserted through a hole in the lid into the cup. In this embodiment, the body of the device comprises a plurality of spaced apart elongated generally rectangular slots through which a fluid or beverage may enter to contact or pass over the flavored material. In this embodiment, the cap covers a top end of the elongated body of the device and comprises a contoured upwardly standing grip portion which may be grasped, for example, using two fingers. The grip portion comprises a contoured tab or central wall that is integrally formed with a disc-like cap body having dimensions to snugly fit over a top end of the device. The body is generally cylindrical and has an outwardly flared upper portion. In this embodiment, as seen in FIG. 3D, when the device is placed in the cup, the outwardly flared upper portion of the device causes the top portion of the body to remain above a plane of the lid of the cup. In this manner, holes in the cap of the device will be positioned close to the nose of the consumer when the beverage is consumed.

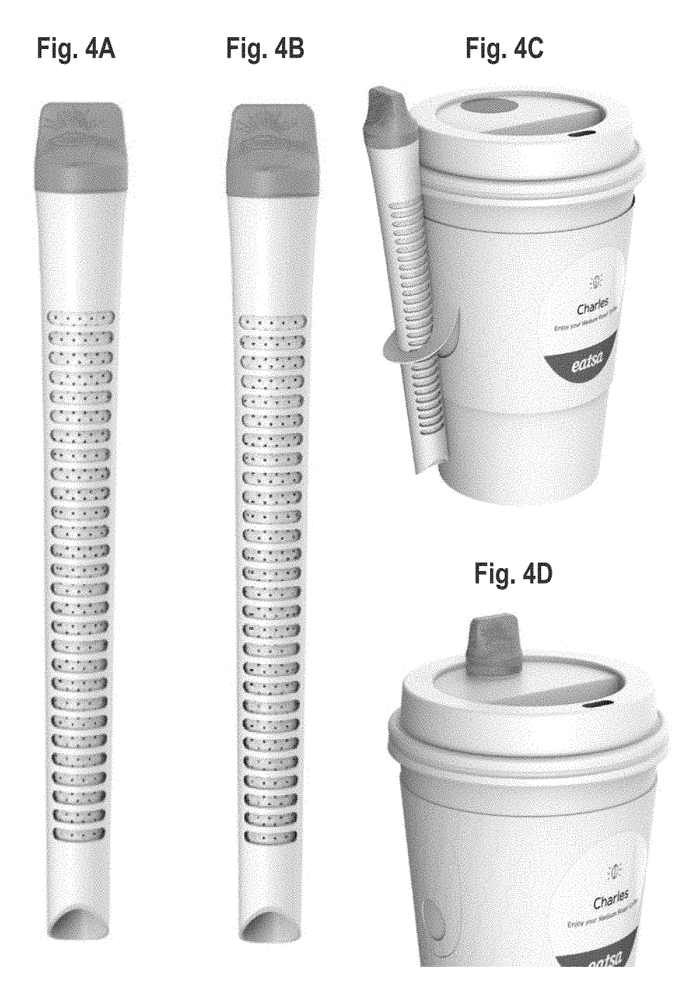

FIG. 4A, FIG. 4B, FIG. 4C, FIG. 4D illustrate another embodiment of a flavor infusing device and system. FIG. 4A is a front elevation view and FIG. 4B is a side elevation view. FIG. 4C is a perspective view of a system comprising a cup, lid, retaining ring and flavor infusing device. FIG. 4D is a perspective view of the system of FIG. 4C showing the device inserted through a hole in the lid into the cup. In this embodiment, the body of the device comprises a plurality of spaced apart lateral slots, each generally rectangular, through which a fluid or beverage may enter to contact or pass over the flavored material. The slots are formed perpendicular to a longitudinal or linear axis of the device body. In this embodiment, the cap covers a top end of the elongated body of the device and comprises a contoured upwardly standing grip portion which may be grasped, for example, using two fingers. The grip portion comprises a contoured tab or central wall that is integrally formed with a disc-like cap body having dimensions to snugly fit over a top end of the device. The body is generally cylindrical and has an outwardly flared upper portion. In this embodiment, as seen in FIG. 4D, when the device is placed in the cup, the outwardly flared upper portion of the device causes the top portion of the body to remain above a plane of the lid of the cup. In this manner, holes in the cap of the device will be positioned close to the nose of the consumer when the beverage is consumed.

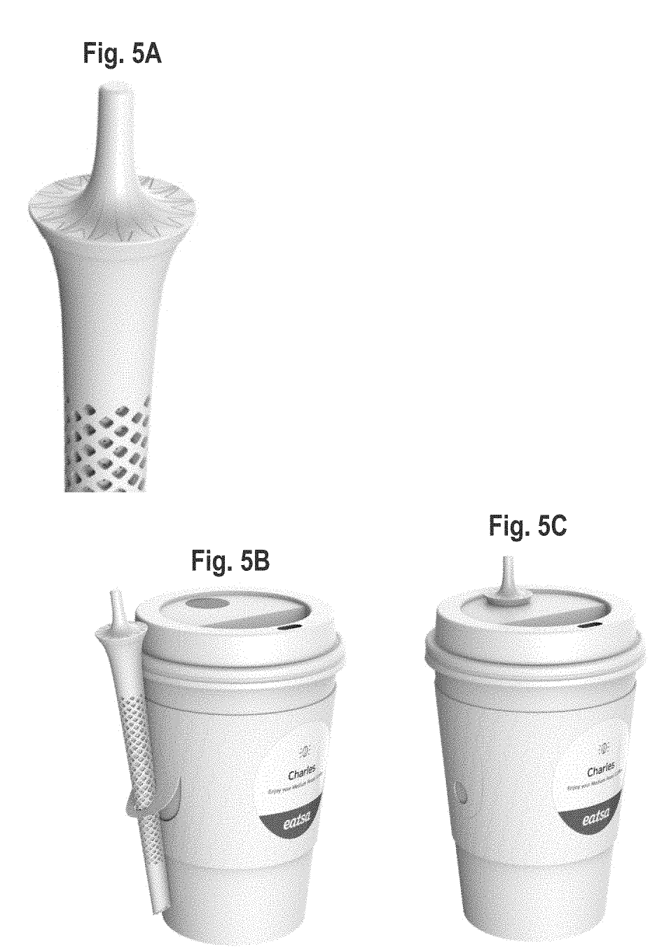

FIG. 5A, FIG. 5B, FIG. 5C illustrate another embodiment of a flavor infusing device and system. FIG. 5A is a perspective view of the device. FIG. 5B is a perspective view of a system comprising a cup, lid, retaining ring and flavor infusing device. FIG. 5C is a perspective view of the system of FIG. 5B showing the device inserted through a hole in the lid into the cup. In this embodiment, the body of the device comprises a plurality of perforations or holes, each of which may be generally square, in a spiral grid pattern around a portion of the entire outer surface of the device. The device body contains an upper region and a lower region that are not perforated. Perforations in the upper region are not required for that portion of the device that would not contact fluid or beverage when placed in a cup. Perforations in the lower region may be omitted for aesthetic or design reasons such as to provide symmetry with respect to the upper region, or to promote structural stability and strength of the body. In this embodiment, the cap covers a top end of the elongated body of the device and comprises a centrally upwardly standing grip portion. The grip portion comprises a contoured rod or cylinder that is integrally formed with a disc-like cap body having dimensions to snugly fit over a top end of the device; the rod or cylinder may comprise a gradually increasing perimeter diameter forming a fillet that transitions to the disc-like cap body. Outer surfaces of the cap may receive indicia, color, molded or engraved designs, or other ornamental embellishments that may indicate or suggest a flavor, type or size of the flavor infusing device. The body is generally cylindrical and has an outwardly flared upper portion. In this embodiment, as seen in FIG. 5C, when the device is placed in the cup, the outwardly flared upper portion of the device causes the top portion of the body to remain above a plane of the lid of the cup. In this manner, holes in the cap of the device will be positioned close to the nose of the consumer when the beverage is consumed.

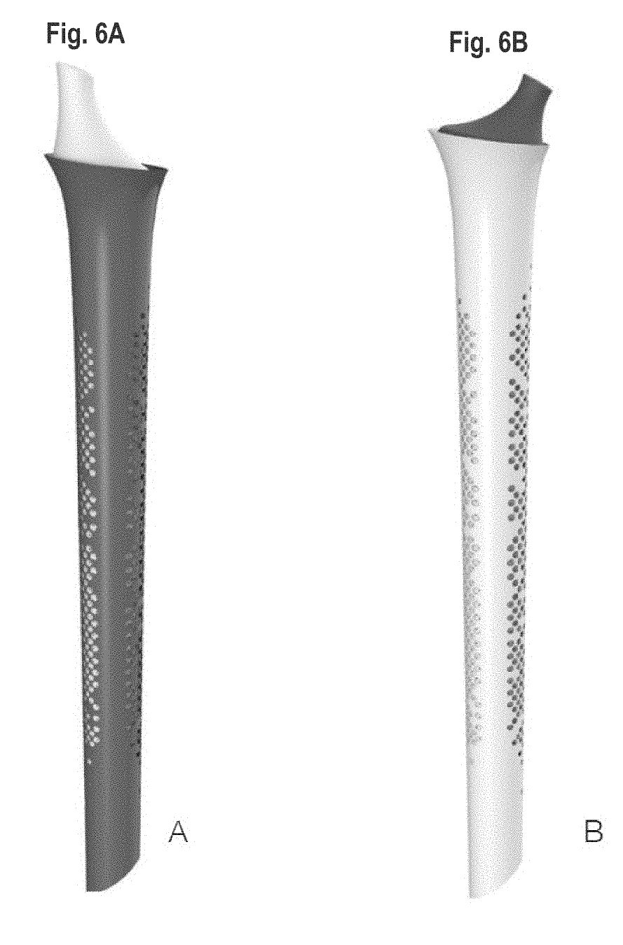

FIG. 6A, FIG. 6B are side elevation views of another embodiment of a flavor infusing device. In this embodiment, the elongated body of the device comprises a plurality of perforations or holes arranged in an ornamental pattern of diagonally situated rows or groups. The number, size, and angle of diagonal of the perforations may vary in different embodiments and the particular pattern shown in FIG. 6A, FIG. 6B is merely an example. In an embodiment, the elongated body of the device comprises an elongated center surface region having no perforations. The width and length of this region may vary in different embodiments either for ornamental design reasons or to promote structural strength of the body. In this embodiment, the cap covers the top end of the elongated body of the device and comprises an angularly tapered upwardly protruding element, which may have a portion of a perimeter area that extends upwardly generally vertically and another perimeter area that is angled or biased to one side or the other. This element is provided for aesthetic and design appeal in this embodiment and does not serve a specific mechanical or utilitarian function.

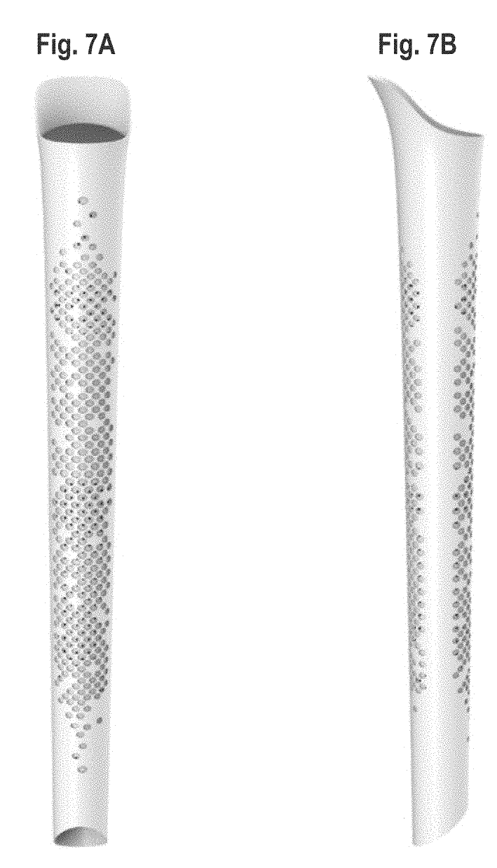

FIG. 7A, FIG. 7B are a front elevation view and a side elevation view of another embodiment of a flavor infusing device. In this embodiment, the elongated body of the device comprises a plurality of perforations or holes arranged in an ornamental pattern of diagonally situated rows or groups. The number, size, and angle of diagonal of the perforations may vary in different embodiments and the particular pattern shown in FIG. 7A, FIG. 7B is merely an example.

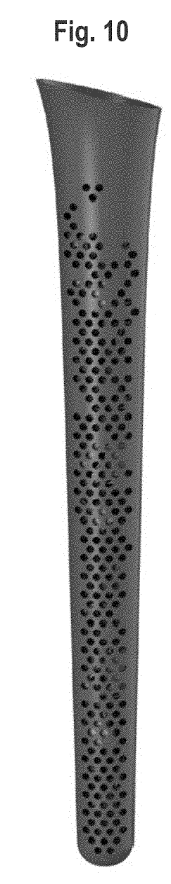

FIG. 10 is a side elevation of another embodiment of the body of the flavor infusing device of FIG. 7A, FIG. 7B to clearly illustrate an example of perforations and an ornamental pattern of the perforations. In these examples, round perforations are shown but perforations formed as squares, triangles or other polygons may be used in other embodiments.

In an embodiment, the elongated body of the device comprises an elongated center surface region having no perforations. The width and length of this region may vary in different embodiments either for ornamental design reasons or to promote structural strength of the body. In this embodiment, an upper end of the elongated body of the device comprises an outwardly flared lip that extends partly upwardly from a perimeter of an upper opening of the elongated body. That is, a portion of the perimeter wall of the upper end of the elongated body of the device extends further upwardly and slightly outwardly. In this embodiment, the cap is recessed within the top opening of the elongated body of the device to sit below a perimeter of a top end of the device.

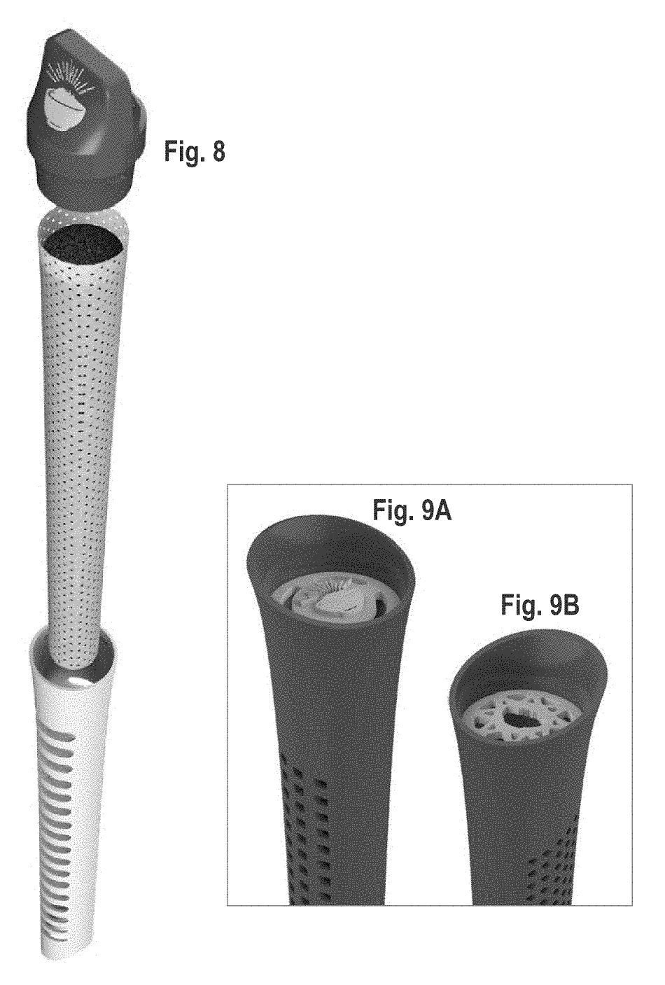

FIG. 8 is an exploded perspective view of the embodiment of a flavor infusing device as seen in FIG. 4A, FIG. 4B, FIG. 4C, FIG. 4D. In this embodiment, the body of the device comprises a plurality of spaced apart lateral slots, each generally rectangular, through which a fluid or beverage may enter to contact or pass over the flavored material. The slots are formed perpendicular to a longitudinal or linear axis of the device body. In an embodiment, the interior cavity contains and conceals a tapered cylinder that contains a flavor infusing material. The tapered cylinder is perforated or may comprise a mesh. In this embodiment, the cap covers a top end of the elongated body of the device and comprises a contoured upwardly standing grip portion which may be grasped, for example, using two fingers. The grip portion comprises a contoured tab or central wall that is integrally formed with a disc-like cap body having dimensions to snugly fit over a top end of the device. The body is generally cylindrical and has an outwardly flared upper portion.

FIGS. 9A and 9B illustrate examples of caps that may be recessed in the elongated body of a flavor infusing device, for example in the devices of FIG. 2A, FIG. 2B. In one embodiment, the cap comprises a plurality of slots arranged circumferentially near a perimeter edge of the cap. The size or angle that each slot subtends may vary in different embodiments for ornamental or aesthetic reasons. In another embodiment, the cap comprises a plurality of triangular orifices arranged in a star pattern or other pattern for aesthetic or design reasons. A central orifice may be provided that is larger than the triangular orifices.

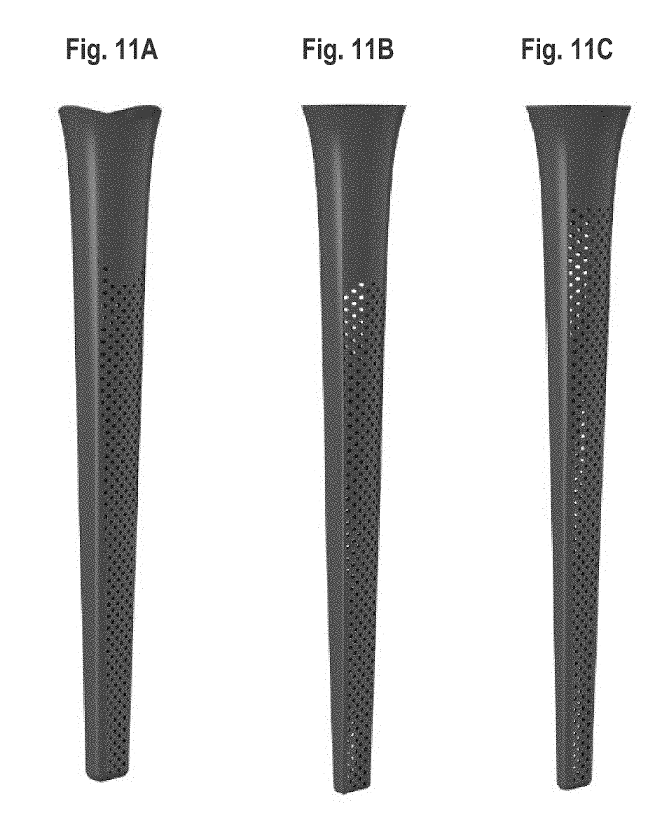

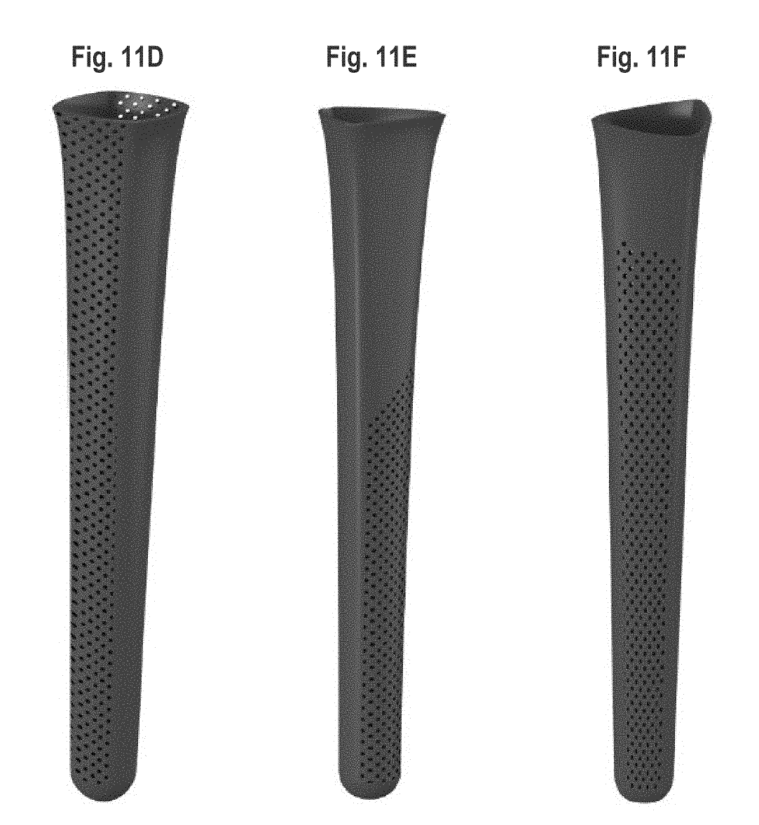

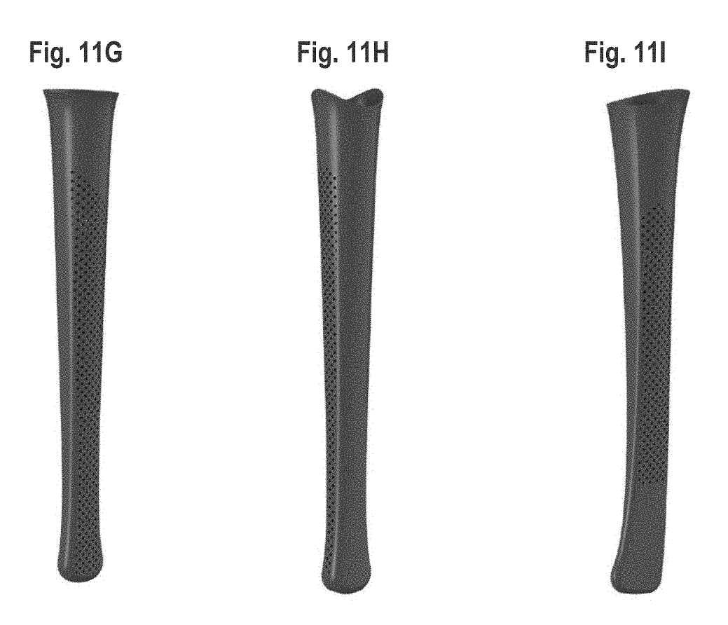

FIG. 11A, FIG. 11B, FIG. 11C illustrate various embodiments of a body of a flavor infusing device and show alternatives or variants in perforation patterns, perforation locations, upper end profiles, and body profiles or cross-sections. In various embodiments, the perforations may extend fully to a lower end of the body and may extend upwardly according to different amounts or lengths. Groups of perforations may form upper terminal or end patterns of different types such as chevrons, angles, and straight lines. The top end of the elongated body may have a laterally flat edge or perimeter as in FIG. 11B, FIG. 11C or a cupped or inwardly angled profile as in FIG. 11A. The cross-section of the elongated body may comprise a square, rounded square or rectangle so that the body has the form of a tapered square or rounded square tube, rather than a cylinder. The amount of taper from top end to bottom end may vary so that the bottom end may vary from a relatively thick bottom end, as in FIG. 11A, to a relatively thin or pointed end, as in FIG. 11C. The bottom end may terminate in a closed end that is a rounded end as in FIG. 11A, FIG. 11C, or a squared off and straight end as in FIG. 11B.

FIG. 11D, FIG. 11E, FIG. 11F illustrate various embodiments of a body of a flavor infusing device and show alternatives or variants in perforation patterns, perforation locations, upper end profiles, and body profiles or cross-sections. In various embodiments, the perforations may extend fully to a lower end of the body and may extend upwardly according to different amounts or lengths, including the entire length as in FIG. 11D or half of the length of the body or less as in FIG. 11E. Groups of perforations may form upper terminal or end patterns of different types such as angles, and straight lines. One or two sides of the body may have no perforations as in FIG. 11D for the right side and left side which is partly obscured in the drawing. The top end of the elongated body may have a laterally flat edge or perimeter as in FIG. 11B, FIG. 11C or a cupped or inwardly angled profile as in FIG. 11A. The cross-section of the elongated body may comprise a triangle, rounded square or rounded triangle so that the body has the form of a tapered rounded square tube as in FIG. 11D or a tapered triangular tube as in FIG. 11E, FIG. 11F. The amount of taper from top end to bottom end may vary. In some embodiments, the bottom end may comprise a relatively thick blunt rounded and closed bottom end as seen in all of FIG. 11D, FIG. 11E, FIG. 11F.

FIG. 11G, FIG. 11H, FIG. 11I illustrate various embodiments of a body of a flavor infusing device and show alternatives or variants in perforation patterns, perforation locations, upper end profiles, and body profiles or cross-sections. In various embodiments, the perforations may extend fully to a lower end of the body and may extend upwardly according to different amounts or lengths. Groups of perforations may form upper terminal or end patterns of different types such as angles, and straight lines. One or two sides of the body may have no perforations as in FIG. 11H for the right side and left side which is partly obscured in the drawing. The top end of the elongated body may have a laterally flat edge or perimeter as in FIG. 11G or a cupped or angled profile as in FIG. 11H, FIG. 11J. The elongated body may have a complex taper that tapers downwardly to a thinner profile but flares slightly outwardly for a portion. The amount of taper from top end to bottom end, and along the side dimensions, may vary. In some embodiments, the bottom end may comprise a relatively thick blunt rounded and closed bottom end as seen in all of FIG. 11G, 11H, or a thinner, blade-like end as seen in FIG. 11G. That is, in various embodiments, both the lateral thickness of the device may taper downwardly toward the bottom of the device, and the longitudinal width of the device may taper separately at a different rate as well.

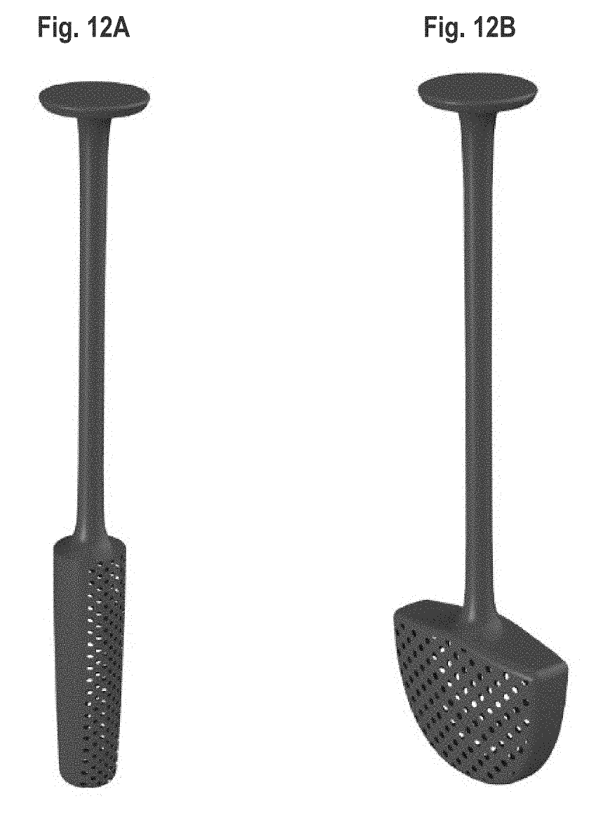

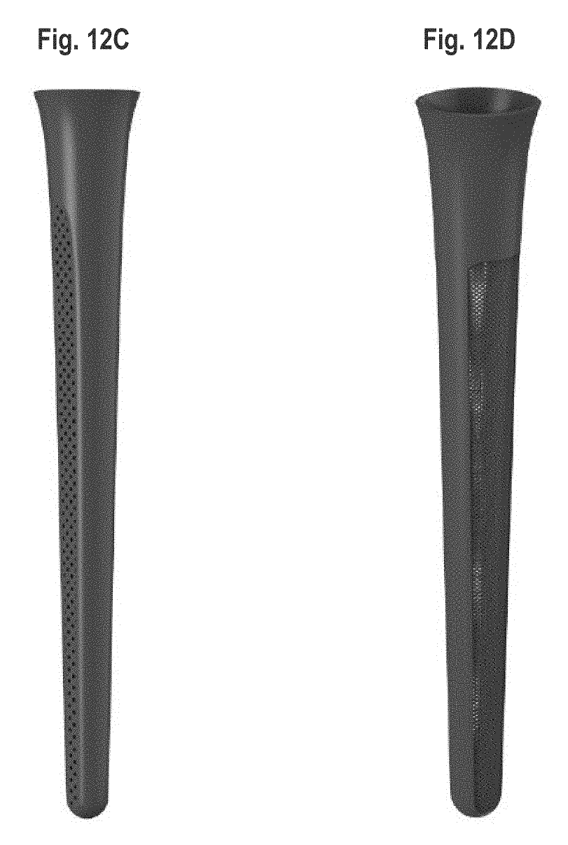

FIG. 12A, FIG. 12B illustrate embodiments of a flavor infusing device comprising a top disc, a shaft, and a perforated body. The shaft is elongated and may be solid. The shaft has a first end that is joined to or integrally formed with the top disc and a second end that is joined to or integrally formed with a top solid generally planar wall of the perforated body. The perforated body may be constructed as an elongated cylinder, as seen in FIG. 12A, having a lower portion that tapers inwardly to a smaller diameter than the diameter of a top portion. Perforations may be provided in all or a portion of the body so that a non-perforated region of the body may be present. In the embodiment of FIG. 12B, the perforated body comprises has a semi-circular profile with a circumferential wall that is non-perforated. The body, in this embodiment, may comprise two semi-circular front and rear walls that are joined by the circumferential wall and a generally rectangular top wall that is non-perforated and joined to the shaft. All walls may be integrally formed rather than joined as separate parts.

FIG. 12C, FIG. 12D illustrate embodiments of a flavor infusing device comprising an elongated tapered partly perforated body. In various embodiments, the body may comprise large or small perforations arranged in an elliptical pattern or in a mesh formation. The body may comprise an open top end that is outwardly tapered and has a diameter larger than that of the body. The body may comprise a closed bottom end having a diameter that is less than the open top end. The cross-section of the body may be round, square, or a rounded square.

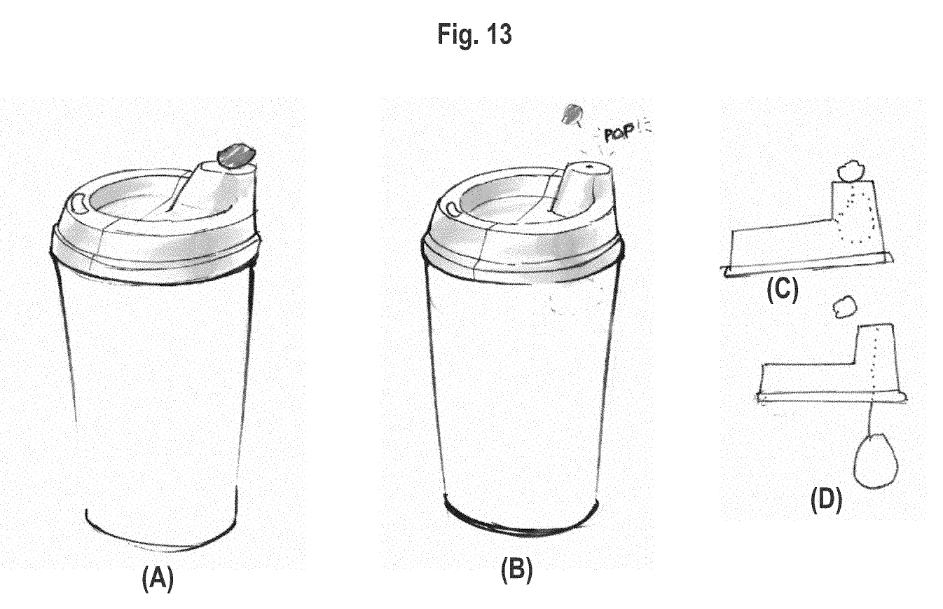

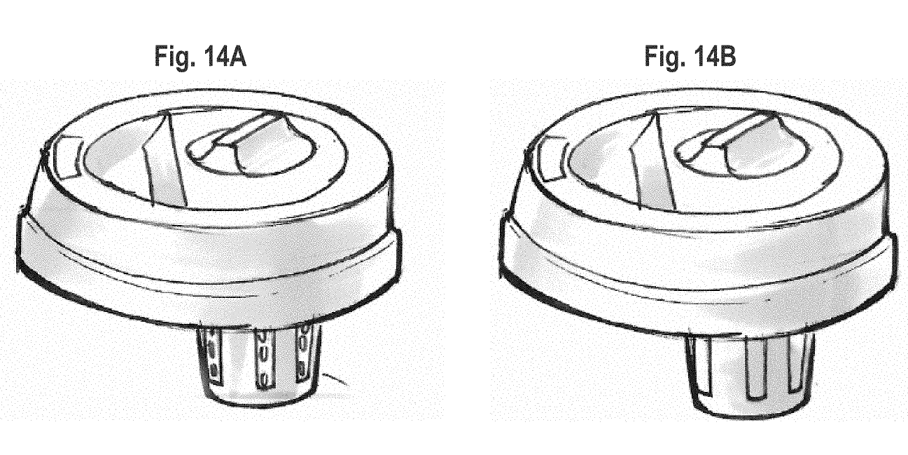

FIG. 13 is a four-part perspective view of a beverage serving system comprising a cup, lid, and flavor infusing device, in one embodiment. As seen in view (A), in an embodiment, a cup containing a beverage or fluid may comprise a lid that is snugly fitted to a top opening of the cup and comprises a consumption hole or slot and an upstanding flavor infuser cover having a hole that may be sealed with a seal. As seen in the partial cross section of view (C), the seal may be removably joined to a flavor infusing bag or capsule that is initially retained above the fluid or beverage within the upstanding flavor infuser cover. As seen in view (B), a consumer may initiate infusing flavor to the beverage or fluid by removing the seal. In response, as seen in view (D), the flavor infusing bag or capsule is released and drops downward. At this point, the flavor infusing bag or capsule contacts or enters the fluid or beverage and an infusing effect may occur as the fluid or beverage enters perforations or holes in the bag or capsule and imparts flavor to the fluid or beverage.

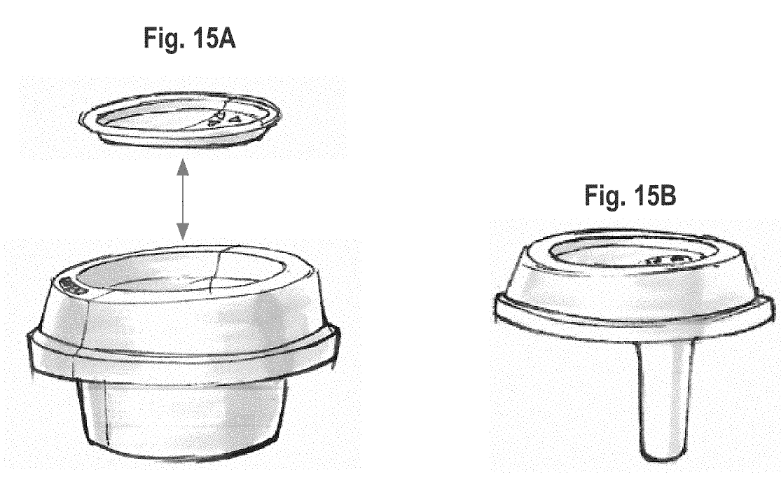

FIG. 14A, FIG. 14B are perspective views of an embodiment of a lid having a rotatable flavor infusing device. In this embodiment, a rotating upstanding knob is recessed in a corresponding cavity in the lid. The knob is joined to or integrally formed with a cylindrical body that contains a flavor infusing material and is partly perforated. The perforations are arranged in vertical rows around a circumference of an outer wall of the tubular body, which may be cylindrical, square, or variable in cross section from round to square, round to rectangular, and so forth. The body has a planar circular bottom wall that contains the material within the body. The cylindrical body fits within and can rotate within a slightly larger cylindrical or frustoconical basket having a plurality of vertical slots or channels spaced apart around the circumference of the basket. In this arrangement, rotating the knob causes the body to rotate with the knob, thereby selectively exposing the perforations through the slots of the basket. When the perforations are exposed, the fluid or beverage in a cup to which the lid is attached may be infused with flavor from the material, as the exposed position permits the fluid or beverage to permeate the basket and the cylindrical body to contact the flavor infusing material within the body. The infusion process may be reduced or stopped by again rotating the handle to conceal the perforations of the body so that they are not exposed via the slots.

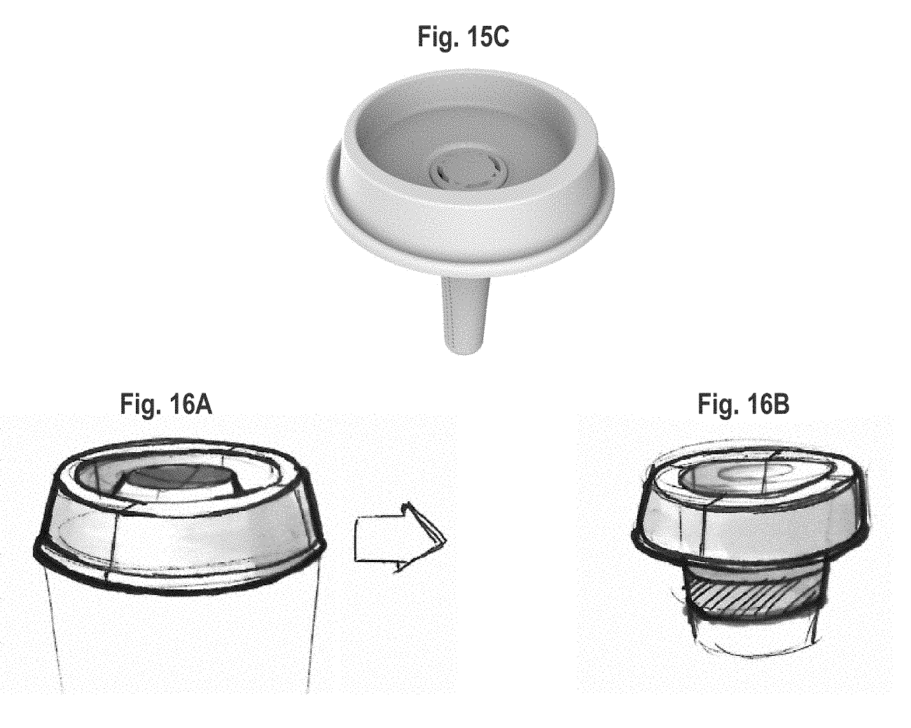

FIG. 15A is an exploded perspective view of a cap and a lid comprising a downwardly extending infusing body. In this embodiment, a cup lid is integrally formed with or attached to the downwardly extending infusing body, which contains a solid infusing material and has a perforated bottom wall. A removable cap may be installed over a top opening in the lid after the solid material has been loaded into the infusing body.

FIG. 15B is a perspective view of an embodiment of a lid for a cup that comprises an elongated downwardly extending flavor infusing body. In this embodiment, a cup lid is integrally formed with or attached to the downwardly extending infusing body, which contains a solid infusing material and has a perforated bottom wall. A removable cap may be installed over a top opening in the lid after the solid material has been loaded into the infusing body. The embodiment of FIG. 15B is mechanically and functionally similar to the embodiment of FIG. 15A, except that the infusing body is elongated more greatly and has a narrower diameter. FIG. 15C is a higher angle perspective view of the embodiment of FIG. 15B, showing a cap comprising a plurality of arcuate slots, and showing a set of partial perforations in the downwardly extending body. In various embodiments, the flavor infusing body may be affixed to the cap in a central position that is centered below the cap and centered with respect to a center point of a circle defining a circumference of the lid, or offset radially from the center.

FIG. 16A, FIG. 16B are perspective views of an embodiment in non-dispensed and dispensed positions. As seen in FIG. 16A, in an embodiment, a cup containing a beverage or fluid may comprise a lid that is snugly fitted to a top opening of the cup and comprises a consumption hole or slot and an upstanding flavor infuser cover having a hole that may be sealed with a seal. The lid may comprise an upstanding perimeter wall that is joined to an interior ring and to the flavor infuser cover. The seal may be removably joined to a flavor infusing capsule or body that is initially retained above the fluid or beverage within the upstanding flavor infuser cover. Retention may be accomplished using an expandable and collapsible bellows structure that is initially collapsed in the position of FIG. 16A and then expanded to permit the capsule or body to enter the fluid in the position of FIG. 16B.

In this position, a consumer may initiate infusing flavor to the beverage or fluid by pressing downward on the center portion of the lid or upon the seal. In response, the flavor infusing capsule or body is urged downward, while remaining attached to the lid, thereby rapidly expanding the bellows structure and adopting an expanded position. In some embodiments, a snapping sound may accompany this downward expansive motion. At this point, the flavor infusing capsule or body contacts or enters the fluid or beverage and an infusing effect may occur as the fluid or beverage enters perforations or holes in the bag or capsule and imparts flavor to the fluid or beverage. FIG. 16B illustrates the resulting position in which the capsule or body has popped downward via mechanical action.

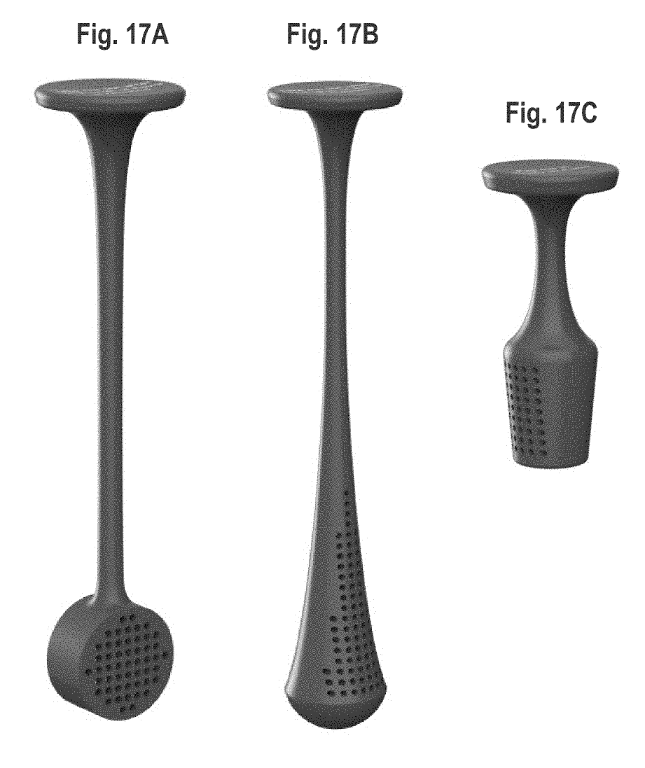

FIG. 17A, FIG. 17B, FIG. 17C illustrate embodiments of a flavor infusing device comprising a top disc, a shaft, and a perforated body. The shaft is elongated and may be solid. The shaft has a first end that is joined to or integrally formed with the top disc and a second end that is joined to or integrally formed with a top solid generally planar wall of the perforated body. The perforated body may be constructed as a thick perforated disc, as seen in FIG. 17A, in which the body comprises two circular front and rear walls that are perforated, joined by or integrally formed with a circumferential side wall. Or, as seen in FIG. 17B, the body may comprise an elongated cone having an apex that is integrally formed with and tapered into the shaft. A bottom end of the cone may be closed by a hemispherical bottom wall that is imperforate. All or a portion of the cone may be perforated or may comprise mesh walls.

FIG. 17C illustrates an embodiment in which the shaft is relatively short as compared to the body, which may comprise a perforated tapered cylinder having a round bottom wall with a diameter that is less than that of an upper portion of the body. All or a part of the circumferential outer wall of the body may be perforated.

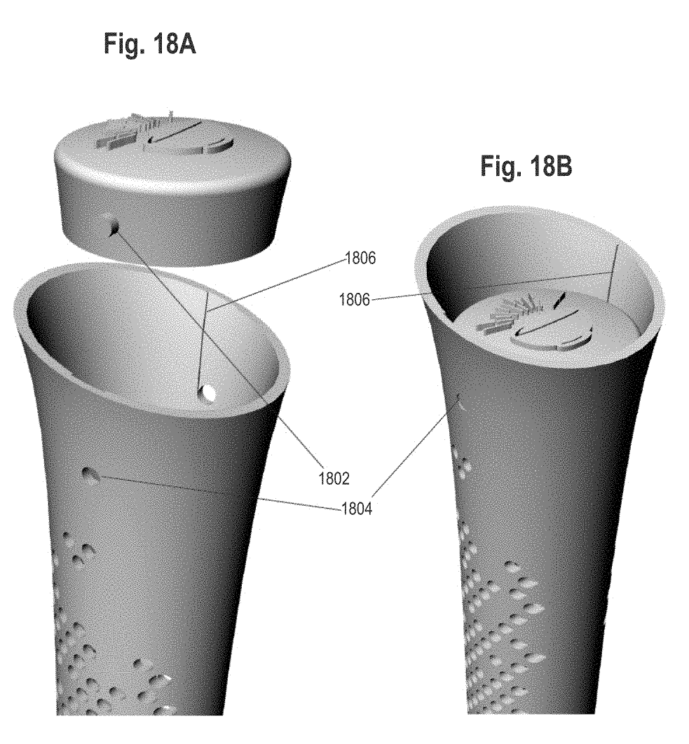

FIG. 18A, FIG. 18B are partial perspective views of an upper portion of a flavor infusing device showing details of one embodiment of a cap and cap securing apparatus. In an embodiment, a flavor infusing device comprises an elongated tapered partly perforated body having a flared upper end with a circular upper opening. A cap comprises a circular top wall joined to or integrally formed with a circumferential side wall. Dimensions are not critical but the vertical height of the side wall typically is less than one diameter of the circular top wall. In an embodiment, the cap comprises two or more outwardly protruding bosses 1802. An inside wall of the top operation of the device comprises two or more slots 1806 or elongated recesses that are arranged longitudinally, and two or more holes 1804 that are spaced apart from a top edge of the circular upper opening. In this arrangement, assembly of the cap to the body may comprise placing the bosses 1802 in the slots 1806 and guiding or pressing the cap downward into the body until the bosses meet and snugly engage the holes 1804. This process results in a cap that is snugly retained in the upper opening of the body, closing off the opening and preventing solid material in the body from spilling out the upper opening if the body is inverted or turned.

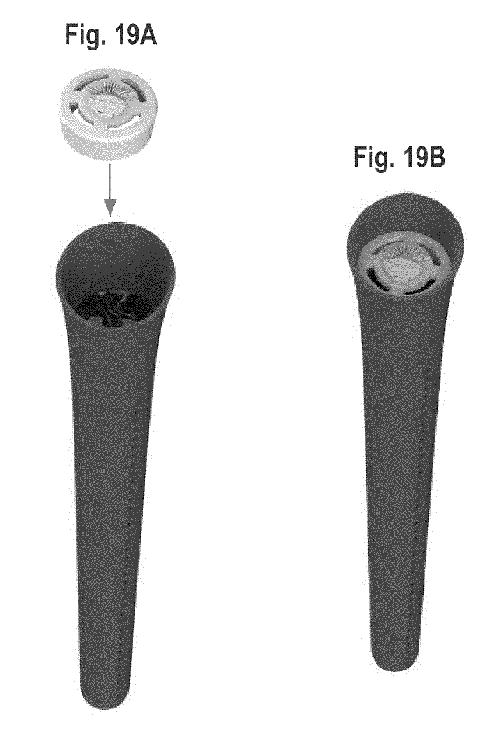

Optionally, the cap may include one or more slots, holes, removable elements, or other openings that permit the consumer to sense aromatic qualities of solid material in the body. FIG. 19A, FIG. 19B are perspective views of a flavor infusing device similar to that of FIG. 18A, FIG. 18B illustrating an alternative cap embodiment, in which the cap comprises a plurality of arcuate slots extending partly around regions of a perimeter of the circular top wall of the cap. FIG. 19A is an exploded view showing that the cap may be initially manufactured as a separate element and then press fit or otherwise snugly joined to the body. FIG. 19B illustrates the same elements in which the cap is installed in a recessed position within the body.

The embodiments described herein may be manufactured using a variety of materials and processes. In some embodiments, the flavor infusing device is made from a food-grade plastic. Examples may include any of several polyethylenes (PET, HDPE, LDPE), natural polylactic acids, polypropylene, and so forth. Cups may be paper, plastics, ceramics or non-reactive metals such as aluminum. Lids may be plastics as set forth above, ceramics or non-reactive metals. Caps for flavor infusing devices may be any of the plastics noted above as well as polystyrenes. Seals may be paper with self-adhesive gum, plastics, polystyrene, nylon, etc. Perforation diameters are not critical and could be about 1 mm, for example.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1.-8. (canceled)

9. A device for infusing flavor into a fluid, comprising:
a cup lid having a circumferential perimeter wall that is configured to engage and cover a top opening of a beverage cup, and comprising an upstanding annular ridge and a dispensing hole in a top surface of the annular ridge;
a flavor infuser cover that is integrated with the lid;
a flavor infusing bag that is attached to the flavor infuser cover and separable therefrom; and
a removable seal that is attached to the flavor infusing bag such that removal of the seal releases the flavor infusing bag from the flavor infuser cover into the cup.

10. The device of claim 9, wherein the flavor infuser cover comprises a tapered cylinder extending vertically from a top surface of the lid and a conical frustum.

11. The device of claim 10, further comprising a hole in the conical frustum that is connected to the seal.

12. The device of claim 11, wherein, relative to a center point of a circumference of the lid, an outer circumference of the annular ridge forms a portion of an outer surface of the flavor infuser cover.

13. The device of claim 9, wherein the seal comprises a removable tab.

14. The device of claim 9, wherein the flavor infuser cover is located along a straight angle from the hole in the top surface of the annular ridge.

15. The device of claim 9, wherein the flavor infusing bag contains a solid infusing material.

16. A device for infusing flavor into a fluid, comprising:
a lid that is configured to engage with and cover a top opening of a cup;
a downwardly extending infusing body that is extends through a hole in the lid and into an interior space of the cup, the body comprising a top opening and a perforated bottom wall; and
a cap on the top opening to seal the top opening of the downwardly extending infusing body, the cap comprising a plurality of slots.

17. The device in claim 16, wherein the downwardly extending infusing body extends through a hole in the lid in a central position with respect to a center point of a circumference of the lid.

18. The device in claim 16, wherein the downwardly extending infusion body extends through a hole in the lid in a position that is offset radially from a center point of a circumference of the lid.

19. The device in claim 16, wherein the perforated bottom wall of the downwardly extending infusing body comprises one or more unperforated portions and a set of partial perforations.

20. The device in claim 16, wherein each of the slots is arcuate.

21. The device in claim 16, wherein the downwardly extending infusing body contains a solid infusing material.

22. A device for infusing flavor into a fluid, comprising:
a lid configured to engage with and cover a top opening of a cup, the lid comprising an annular ridge and a hole in a top surface of the annular ridge;
a flavor infuser cover that is inset from an inner circumferential wall of the annular ridge; and
a flavor infusing body that extends through a hole in the flavor infuser cover.

23. The device of claim 22, wherein the flavor infuser cover, in a retracted position, comprises a tapered cylinder extending upward from a base of the inner circumferential wall of the annular ridge.

24. The device of claim 22, wherein the flavor infuser cover, in an expanded position, comprises a tapered cylinder extending downward from a base of the inner circumferential wall of the annular ridge.

25. The device of claim 22, wherein the flavor infuser cover comprises a bellows that is configured to extend downward towards a liquid.

26. The device of claim 23, wherein the flavor infusing body is attached to a conical frustum of the tapered cylinder.

27. The device of claim 24, wherein the flavor infusing body is attached to a conical frustum of the tapered cylinder.

28. The device of claim 22, wherein the flavor infuser cover is affixed to the lid in a central position with respect to a center point of a circumference of the lid.

29. The device of claim 22, wherein the flavor infusing body contains a solid infusing material.
